(19) United States
(12) Patent Application Publication
(10) Pub. No.: US 2013/0051825 A1
(43) Pub. Date: Feb. 28, 2013

(54) PRODUCING MATTE-FINISH PRINT ON RECEIVER

(71) Applicants: Jerry Alan Pickering, Hilton, NY (US); David Francis Cahill, Rochester, NY (US)

(72) Inventors: Jerry Alan Pickering, Hilton, NY (US); David Francis Cahill, Rochester, NY (US)

(21) Appl. No.: 13/220,769

(22) Filed: Aug. 30, 2011

(51) Int. Cl. G03G 15/20

(52) U.S. Cl. 399/45; 399/68; 399/69; 399/67

(57) ABSTRACT

A method of producing a print having a matte finish on a receiver having a surface type includes depositing toner with a viscosity of less than about 10 kpoise in a selected pattern on a receiver. A fixing system is provided including a rotatable fixing member and a pressure member arranged to form a fixing nip between them. The fixing member has a selected non-smooth surface that includes silicone. A release lubricant is applied to the fixing member. A fixing temperature and a fixing speed are selected based on the receiver surface type. The fixing member is heated to have a surface temperature substantially equal to the selected fixing temperature. The fixing member is rotated at the selected fixing speed to draw the toned receiver through the fixing nip, so that the toner is heated and fixed to the receiver and the resulting print has a matte finish.

### CROSS-REFERENCE TO RELATED APPLICATIONS

This application is co-filed with and has related subject matter to U.S. patent application Ser. No. [Docket K000429US01].

### FIELD OF THE INVENTION

This invention pertains to the field of printing and more particularly to producing prints having selected finishes.

### BACKGROUND OF THE INVENTION

Printers are useful for producing printed images of a wide range of types. Printers print on receivers (or “imaging substrates”), such as pieces or sheets of paper or other planar media, glass, fabric, metal, or other objects. Printers typically operate using subtractive color: a substantially reflective receiver is overcoated image-wise with cyan (C), magenta (M), yellow (Y), black (K), and other colorants. Prints can be produced with various surface finishes such as matte or glossy.

U.S. Pat. No. 6,438,336 to Bengtson describes printing elements with varying gloss levels on a single page. This is accomplished by modifying the settings of the fuser and repositioning the page on its other side. However, this scheme suffers because it can only achieve the varying levels of gloss by inverting the page and reprocessing it, which greatly decreases throughput.

U.S. Pat. No. 5,282,001 to Watson describes a reprographic apparatus that recognizes sheet characteristics and sets operational parameters accordingly. Operational parameters in this scheme include fusing temperature. However, this scheme is limited in the range of gloss adjustment it can achieve because only certain combinations of fusing speed and fusing temperature will effectively fuse images onto the receiver.

U.S. Pat. No. 6,101,345 to Van Goethem et al. describes a method for achieving a pre-selected gloss in an electrographic image printing system by choosing the appropriate combination of fusing speed and fusing temperature. However, this scheme suffers from limitations similar to those of the '001 reference.

### SUMMARY OF THE INVENTION

Moreover, to produce prints with a matte finish, it is preferable to use a relatively higher viscosity toner. Such a toner flows more slowly while being fixed and therefore results in an image with relatively greater surface roughness. This greater surface roughness corresponds to a less smooth, i.e., more matte, finish. For producing prints with glossy finishes, it is likewise preferable to use toners with relatively lower viscosity. Color printers generally use lower viscosity toners, as such toners flow more efficiently and therefore can produce a wider range of color combinations than higher viscosity toners. Conventional systems that adjust fuser settings to produce matte finishes are limited in the level of surface roughness they can achieve by the low viscosity of the toners used.

There is therefore a continuing need for a way of producing matte-finish color prints using low viscosity toners.

According to an aspect of the present invention, there is provided a method of producing a print having a matte finish on a receiver having a type, comprising:

depositing toner in a selected pattern on the receiver, wherein the toner has a viscosity of less than about 10 kpoise;

providing a fixing station including a rotatable fixing member and a pressure member arranged to form a fixing nip between them, wherein the fixing member has a selected non-smooth surface that includes silicone;

applying a release lubricant to the fixing member;

selecting a fixing temperature and a fixing speed based on the receiver surface type;

heating the fixing member to have a surface temperature substantially equal to the selected fixing temperature; and

rotating the fixing member at the selected fixing speed to draw the toned receiver through the fixing nip, so that the toner is heated and fixed to the receiver and the resulting print has a matte finish.

According to another aspect of the present invention, there is provided a method of producing a print having a matte finish on a receiver having a type, comprising:

depositing toner in a selected pattern on the receiver, wherein the toner has a viscosity of less than about 10 kpoise;

providing a fixing station including a rotatable fixing member and a pressure member arranged to form a fixing nip between them, wherein a fixing surface of the fixing member includes silicone and has a selected non-smooth surface;

applying a release lubricant to the fixing member;

selecting a fixing force based on the receiver type;

pressing the fixing member and the pressure member together with the fixing force; and

rotating the fixing member to draw the toned receiver through the fixing nip, so that the toner is heated and fixed to the receiver and the resulting print has a matte finish.

An advantage of this invention is that it provides a wide range of image gloss, such as matte. The matte images are similar in surface finish to offset-printed images. Another advantage is that a matte finish can be achieved in a single step instead of requiring reprocessing and inverting of the page. An additional advantage includes low equipment UMC.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus;

FIG. 2 shows details of a fixing system according to various embodiments;

FIG. 3 is a high-level diagram showing the components of a processing system useful with various embodiments;

FIG. 4 is a flowchart of methods of producing a print having a matte finish on a receiver; and

FIG. 5 is a diagram of various embodiments of a receptacle useful with the system shown in FIG. 2.

The attached drawings are for purposes of illustration and are not necessarily to scale.

### DETAILED DESCRIPTION OF THE INVENTION

In the following description, some embodiments will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, methods described herein. Other aspects of such algorithms and systems, and hardware or software for producing and otherwise processing the image signals involved therewith, not specifically shown or described herein, are selected from such systems, algorithms, components, and elements known in the art. Given the system as described herein, software not specifically shown, suggested, or described herein that is useful for implementation of various embodiments is conventional and within the ordinary skill in such arts.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice methods according to various embodiments.

The electrophotographic (EP) printing process can be embodied in devices including printers, copiers, scanners, and facsimiles, and analog or digital devices, all of which are referred to herein as “printers.” Electrostatographic printers such as electrophotographic printers that employ toner developed on an electrophotographic receiver is used, as can ionographic printers and copiers that do not rely upon an electrophotographic receiver. Electrophotography and ionography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the receiver, and one or more post-printing finishing system(s) (e.g. a UV coating system, a glosser system, or a laminator system). A printer can reproduce pleasing black-and-white or color onto a receiver. A printer can also produce selected patterns of toner on a receiver, which patterns (e.g. surface textures) do not correspond directly to a visible image. The DFE receives input electronic files (such as Postscript command files) composed of images from other input devices (e.g., a scanner, a digital camera). The DFE can include various function processors, e.g. a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, media type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g. the electrophotographic process) to provide known, consistent color reproduction characteristics. The color management system can also provide known color reproduction for different inputs (e.g. digital camera images or film images).

In an embodiment of an electrophotographic modular printing machine, e.g. the NEXPRESS 3000SE printer manufactured by Eastman Kodak Company of Rochester, N.Y., color-toner print images are made in a plurality of color imaging modules arranged in tandem, and the print images are successively electrostatically transferred to a receiver adhered to a transport web moving through the modules. Colored toners include colorants, e.g. dyes or pigments, which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

Electrophotographic printers having the capability to also deposit clear toner using an additional imaging module are also known. As used herein, clear toner is considered to be a color of toner, as are C, M, Y, K, and Lk, but the term “colored toner” excludes clear toners. The provision of a clear-toner overcoat to a color print is desirable for providing protection of the print from fingerprints and reducing certain visual artifacts. Clear toner uses particles that are similar to the toner particles of the color development stations but without colored material (e.g. dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective toners are deposited one upon the other at respective locations on the receiver and the height of a respective toner stack is the sum of the toner heights of each respective color. Uniform stack height provides the print with a more even or uniform gloss.

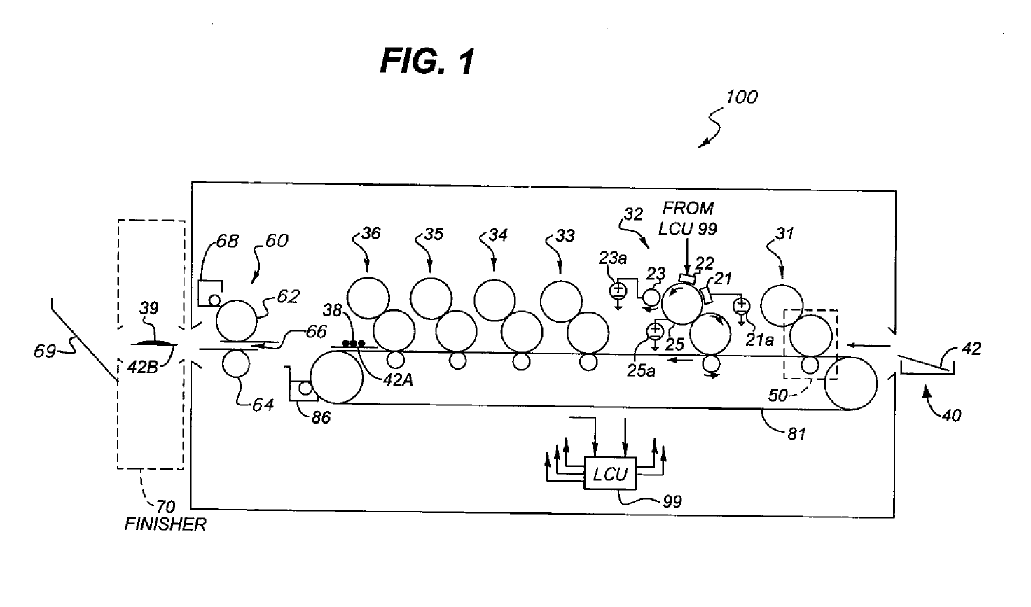

FIG. 1 is an elevational cross-section showing portions of a typical electrophotographic printer 100. Printer 100 is adapted to produce print images, such as single-color (monochrome), CMYK, or hexachrome (six-color) images, on a receiver (multicolor images are also known as “multi-component” images). Images can include text, graphics, photos, and other types of visual content. An embodiment involves printing using an electrophotographic print engine having six sets of single-color image-producing or -printing stations or modules arranged in tandem, but more or fewer than six colors are combined to form a print image on a given receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, 36, also known as electrophotographic imaging subsystems. Each printing module 31, 32, 33, 34, 35, 36 produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various embodiments, the visible image can be transferred directly from an imaging roller to a receiver 42, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film. A receiver can be in sheet or roll form.

Each printing module 31, 32, 33, 34, 35, 36 includes various components. For clarity, these are only shown in printing module 32. Around photoreceptor 25 are arranged, ordered by the direction of rotation of photoreceptor 25, charger 21, exposure subsystem 22, and toning station 23.

In the EP process, an electrostatic latent image is formed on photoreceptor 25 by uniformly charging photoreceptor 25 and then discharging selected areas of the uniform charge to yield an electrostatic charge pattern corresponding to the desired image (a “latent image”). Charger 21 produces a uniform electrostatic charge on photoreceptor 25 or its surface. Exposure subsystem 22 selectively image-wise discharges photoreceptor 25 to produce a latent image. Exposure subsystem 22 can include a laser and raster optical scanner (ROS), one or more LEDs, or a linear LED array.

After the latent image is formed, charged toner particles are brought into the vicinity of photoreceptor 25 by toning station 23 and are attracted to the latent image to develop the latent image into a visible image. Note that the visible image may not be visible to the naked eye depending on the composition of the toner particles (e.g. clear toner). Toning station 23 can also be referred to as a development station. Toner can be applied to either the charged or discharged parts of the latent image.

After the latent image is developed into a visible image on photoreceptor 25, a suitable receiver 42 is brought into juxtaposition with the visible image. In transfer subsystem 50, a suitable electric field is applied to transfer the toner particles of the visible image to receiver 42 to form the desired print image 38 on the receiver, as shown on receiver 42A. The imaging process is typically repeated many times with reusable photoreceptors 25.

Receiver 42A is then removed from its operative association with photoreceptor 25 and subjected to heat or pressure to permanently fix (“fuse”) print image 38 to receiver 42A. Plural print images, e.g. of separations of different colors, are overlaid on one receiver before fusing to form a multi-color print image 38 on receiver 42A.

Each receiver 42, during a single pass through the six printing modules 31, 32, 33, 34, 35, 36, can have transferred in registration thereto up to six single-color toner images to form a pentachrome image. As used herein, the term “hexachrome” implies that in a print image, combinations of various of the six colors are combined to form other colors on receiver 42 at various locations on receiver 42. That is, each of the six colors of toner can be combined with toner of one or more of the other colors at a particular location on receiver 42 to form a color different than the colors of the toners combined at that location. In an embodiment, printing module 31 forms black (K) print images, 32 forms yellow (Y) print images, 33 forms magenta (M) print images, 34 forms cyan (C) print images, 35 forms light-black (Lk) images, and 36 forms clear images.

In various embodiments, printing module 36 forms print image 38 using a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Receiver 42A is shown after passing through printing module 36. Print image 38 on receiver 42A includes unfused toner particles.

Subsequent to transfer of the respective print images 38, overlaid in registration, one from each of the respective printing modules 31, 32, 33, 34, 35, 36, receiver 42A is advanced to a fixing station 60, i.e. a fusing or fixing assembly, to fuse print image 38 to receiver 42A. Transport web 81 transports the print-image-carrying receivers (e.g., 42A) to fixing station 60, which fixes the toner particles to the respective receivers 42A by the application of heat and pressure. The receivers 42A are serially de-tacked from transport web 81 to permit them to feed cleanly into fixing station 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fixing station 60 includes a heated fixing member 62 and an opposing pressure roller 64 that form a fusing nip 66 therebetween. In an embodiment, fixing station 60 also includes a release fluid application substation 68 that applies release fluid, e.g. silicone oil, to fixing member 62. Alternatively, wax-containing toner is used without applying release fluid to fixing member 62. Other embodiments of fusers, both contact and non-contact, can be employed. For example, solvent fixing uses solvents to soften the toner particles so they bond with the receiver 42. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the receivers (primarily), thereby causing the toner particles to melt by heat conduction, so that the toner is fixed to the receiver 42.

The receivers (e.g., receiver 42B) carrying the fused image (e.g., fused image 39) are transported in a series from the fixing station 60 along a path either to a remote output tray 69, or back to printing modules 31, 32, 33, 34, 35, 36 to create an image on the backside of the receiver (e.g., receiver 42B), i.e. to form a duplex print. Receivers (e.g., receiver 42B) can also be transported to any suitable output accessory. For example, an auxiliary fuser or glossing assembly can provide a clear-toner overcoat. Printer 100 can also include multiple fixing stations 60 to support applications such as overprinting, as known in the art.

In various embodiments, between fixing station 60 and output tray 69, receiver 42B passes through finisher 70. Finisher 70 performs various media-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fixing station 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g. color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Various parameters of the components of a printing module (e.g., printing module 31) can be selected to control the operation of printer 100. In an embodiment, charger 21 is a corona charger including a grid between the corona wires (not shown) and photoreceptor 25. Voltage source 21a applies a voltage to the grid to control charging of photoreceptor 25. In an embodiment, a voltage bias is applied to toning station 23 by voltage source 23a to control the electric field, and thus the rate of toner transfer, from toning station 23 to photoreceptor 25. In an embodiment, a voltage is applied to a conductive base layer of photoreceptor 25 by voltage source 25a before development, that is, before toner is applied to photoreceptor 25 by toning station 23. The applied voltage can be zero; the base layer can be grounded. This also provides control over the rate of toner deposition during development. In an embodiment, the exposure applied by exposure subsystem 22 to photoreceptor 25 is controlled by LCU 99 to produce a latent image corresponding to the desired print image. All of these parameters can be changed, as described below.

Further details regarding printer 100 are provided in U.S. Pat. No. 6,608,641, issued on Aug. 19, 2003, to Peter S. Alexandrovich et al., and in U.S. Publication No. 2006/0133870, published on Jun. 22, 2006, by Yee S, Ng et al., the disclosures of which are incorporated herein by reference.

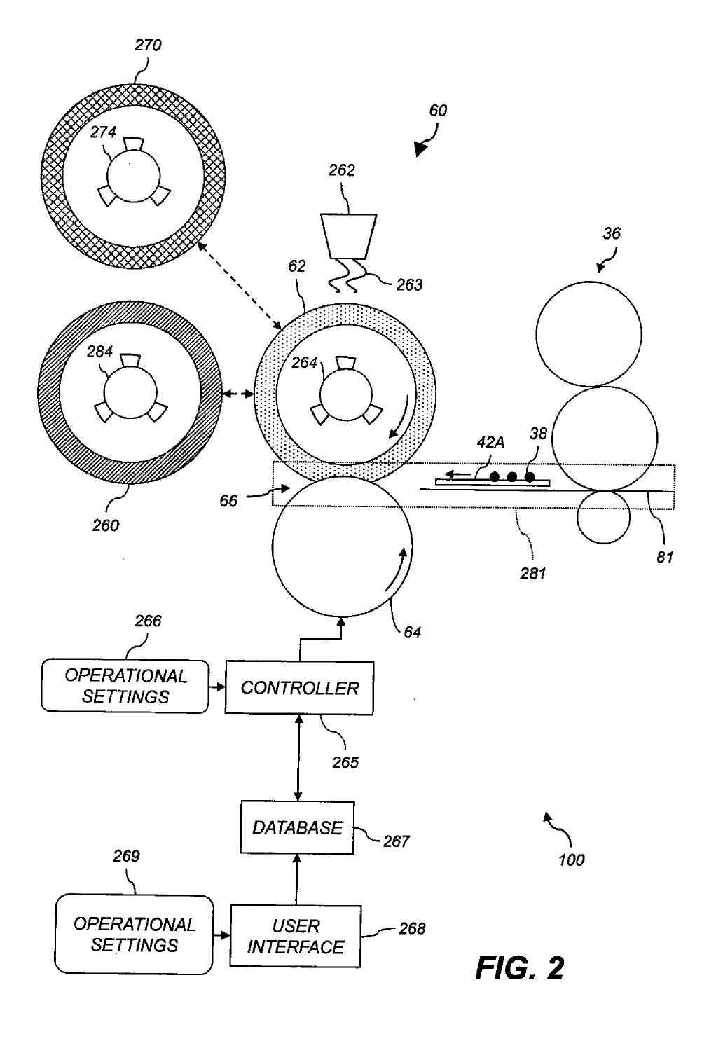

FIG. 2 shows a fixing system according to various embodiments.

Printer 100 is adapted to produce a print having a selected matte or glossy finish on a receiver 42A moving along a transport path. The receiver 42A can be a sheet of paper or another medium that can be printed on and has a surface type and a basis weight. Examples of surface types include uncoated, synthetic, transparencies, matte coated and glossy coated. The basis weight can be measured in g/m².

Printer 100 includes two rotatable fixing members 62, 260. First fixing member 62 is used to produce prints having a matte finish. Second fixing member 260 is used to produce prints having a glossy finish. In various embodiments, each fixing member has a curved surface so that the surface of fixing member 62, 260 that contacts receiver 42A bearing toner powder image 38 makes an appropriate contact angle with receiver 42A. This provides effective release of receiver 42A from fixing member 62, 260. Each fixing member can be a drum including a cylindrical core or a belt. Each fixing member 62, 260 can have a hollow core (not shown), inside of which a heat source (not shown) is placed.

First fixing member 62 has a compliant non-smooth silicone surface. A “non-smooth surface” has an Rₐ>0.15 μm, R_{z} greater than about 6 μm, and Rₘₐₓ greater than about 8 μm. Rₐ can be >1.25 μm. Rₐ is the integral of deviations of the surface from a smoothed average surface, or approximately the average. Rₐ is the average delta between the highest five peaks and the lowest five peaks in sampling length, relative to a smooth averaged surface. Rₘₐₓ is the maximum peak to valley in the sampling length, relative to a smooth averaged surface. In various embodiments, first fixing member 62 is used in the production of prints having matte surface finishes. In various embodiments, the Rₐ is between about 1.25 and 3.2 microns, the R_{z} is between about 6 and 25 microns, and the Rₘₐₓ is between about 8 and 30 microns.

In various embodiments, the elastomeric polyorganosiloxanes, or silicone rubbers, useful for the base cushion can also be used for the fusing surface layer, including RTV, HTV and LIM materials. Both condensation and addition curable silicone can be employed.

The fusing surface layer includes a polyorganosiloxane elastomer with a durometer hardness of between 20 and 75 Shore A, or between 30 and 70 Shore A, or between 40 and 65 Shore A. The conformability of the fusing surface layer also helps to reduce toner contamination provided the layer is not too soft. If the fusing surface is below about 20 Shore A, the toner release is generally degraded. In addition, other properties such as oil swell are likely to be poor.

To reduce the amount of toner offset, the fusing surface layer can include polyorganosiloxane, e.g., a polydimethlysiloxane. “Toner offset” is a term used to describe melted toner during the fixing step that is transferred to a surface other than the intended surface. The volume percent of polyorganosiloxane can be between 40% and 90%, or between 55% and 85%, or between 65% and 80% by volume, based on the total volume of the layer.

In embodiments, the volume percent of silica is preferred to be less than 10 volume percent of the fusing surface layer, more preferably less than 5 volume percent. Silica is often employed in polyorganosiloxanes as a filler for reinforcement; however, it is not desirable in the fusing surface layer. The term “silica” includes fumed, precipitated, natural, or synthetic.

To provide wear resistance, one or more types of filler can be incorporated into the fusing surface layer to increase this layer's durability. For improving the wear resistance, one or more of any fillers which are employed can be used or surface treated with a coupling agent as discussed in U.S. Pat. Nos. 5,998,033; 5,935,712; and 6,114,041. These patents are incorporated herein by reference.

Heat conductive filler particles provide thermal conductivity to the fusing surface layer. Heat conducting fillers have a thermal conductivity of greater than about 5 btu/(hr ft F), and can be metal oxides. Compounds suitable as heat conducting filler particles include SnO2, Si metal, SiC, CuO, ZnO, FeO, Fe₂O3, and Al₂O3. Where heat conductive filler is employed, one or more of these compounds can be used. The fusing surface layer can comprise, dispersed therein, up to about 45 percent by volume, or about 40 percent by volume, or from about 12 to about 28 percent by volume, of heat conducting filler particles based on total volume of the surface layer.

Fillers incorporated in the base cushion and fusing surface layers of the invention can be in one or more shapes, e.g., irregular, spheroids, platelets, flakes, or ovoids. For heat-conducting fillers, an irregular shape can be used, as can spherical particles or platelets. Fibers, needles and other elongated shapes can have an aspect ratio of less than or equal to 5.

The fusing surface layer can be free, or substantially free, of heat conducting filler particles. The fusing surface layer can thus receive and transfer heat for fusing the toner to the receiver without heat conducting filler.

Moreover, roughness of the surface can be increased or decreased, by the fillers. Fillers used in the present invention can have a mean particle diameter of about 0.1 microns to about 80 microns, or about 0.2 microns to about 20 microns.

To provide reduced wear, the filler particles can include a portion of large particles. These large particles can also provide a reduced gloss on the toner surface. To achieve a reduced wear rate, fillers can include 15 to 35 volume percent of particles that are larger than 8 microns, 10 to 25 volume percent larger than 12 microns, or 5 to 15 volume percent larger than 20 microns.

Second fixing member 260 has a compliant smooth fluoropolymer surface with gloss level between 10G60 and 20G60. In another embodiment, the G60 gloss is greater than 35. In various embodiments, second fixing member 260 is used in the production of prints having normal or semi-gloss surface finishes.

By “smooth”, it is meant that second fixing member 260 has Rₐ less than 1.25, R_{z} less than 6 and Rₘₐₓ less than 8 microns. First fixing member 62 has a Rₐ, R_{z} and Rₘₐₓ greater than second fixing member 260.

Fixing member 62, 260 can be installed in a fixing station 60 arranged along transport path 281. The fixing station includes a pressure member 64, receptacle 264, applicator 262, and printing module 36.

Fixing station 60 includes a heated fixing member (e.g., 62, 260, 270) and an opposing pressure member 64 that form a fixing nip 66 therebetween. One of the fixing members 62, 260, 270 is installed in fixing station 60 at any given time. Fixing member 62, 260, 270, or pressure member 64 can be a roller, belt, or ski and can include one or more layers. One or more of the layers can be compliant. For example, pressure member 64 can be a metal drum with a compliant silicone overcoat and can have a surface layer, which is typically a fluoropolymer such as a PFA sleeve or fluoroelastomer coating.

Fixing member 62 includes a heating drum with a silicone or fluoropolymer surface. Fixing member 62, 260, or 270 can be heated by an external source of heat such as by contact with one or more external heating rollers. Alternatively, it can be heated by absorbed radiation, as provided by one or more lamps, or by any other suitable external source of heat. An internally heated fixing member includes an internal heat source, such as a lamp.

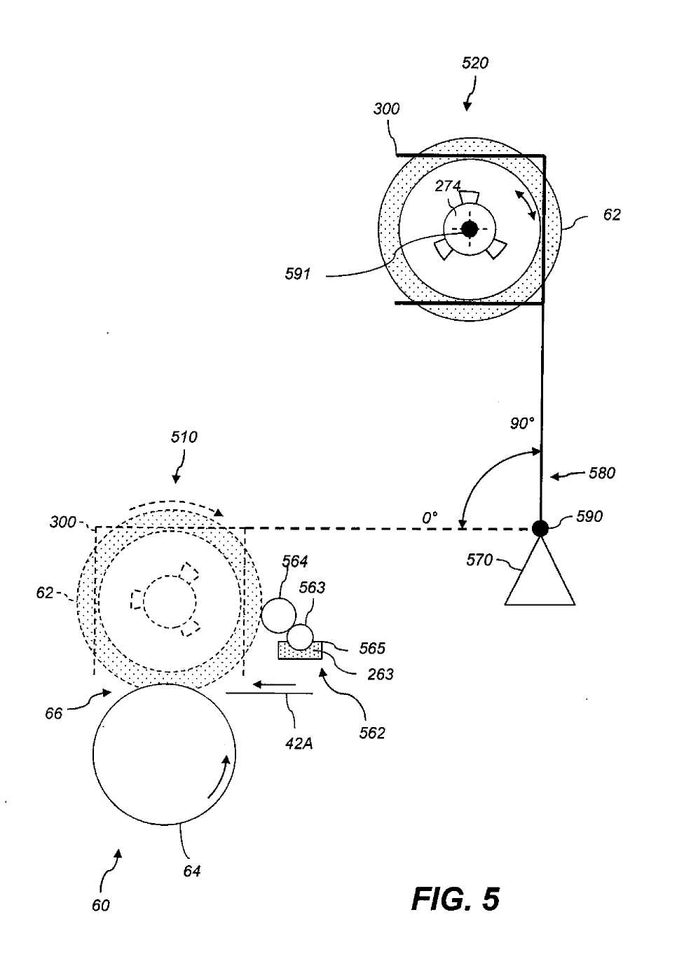

Receptacle 300 (see FIG. 5) is adapted to selectively, i.e., one at a time, receive first fixing member 62, second fixing member 260, or third fixing member 270 depending on the desired finish. Receptacle 300 retains the received fixing member 62, 260, or 270 in operative arrangement with the pressure member 64 to form a fixing nip 66. Bearings 264, 274, 284 can be gudgeons affixed to the metal frame of printer 100 by a rotatable shaft that is also affixed to the metal frame of printer 100. Fixing member 62, 260, or 270 in receptacle 300 can rotate freely while held in place on its central axis.

Applicator 262 applies a lubricant 263 onto the surface of fixing member 62, 260, 270 in order to reduce the risk of offset of the toner from receiver 42A onto fixing member 62, 260, 270. Lubricant 263 can include silicone oil. Further details of various embodiments of applicators and lubricants are described in commonly-assigned U.S. Pat. No. 7,632,562, the disclosure of which is incorporated herein by reference

In various embodiments, the release lubricant 263 contains amines. Some examples of such lubricants are provided in U.S. Pat. No. 4,264,181 and U.S. Pat. No. 5,157,445, the disclosures of which are incorporated herein by reference. The '445 reference describes amines of the form R¹—X where R¹ represents an alkylene group having from 1 to 8 carbon atoms, and X represents —NH₂ or —NHR²NH₂ with R² being an alkylene group having from 1 to 8 carbon atoms. Other examples are described in U.S. Pat. No. 7,074,488, the disclosure of which is incorporated herein by reference.

A printing module 36 is arranged along transport path 281 ahead of fixing station 60. Printing module 36 deposits toner in a selected pattern on receiver 42A. The toner has a viscosity, at a test temperature of 120° C. and 1 rad/s of less than about 10 kpoise. Printing module 36 is as discussed above with respect to FIG. 1.

Controller 265 is adapted to receive operational settings 266 of fixing station 60 corresponding to the selected finish. Operational settings 266 can include heat, time and pressure applied to receiver 42A when it enters fixing nip 66 from transport path 281. Controller 265 operates fixing station 60 at the received operational settings 266 to draw receiver 42A through fixing nip 66. As a result, the toner pattern on receiver 42A is fixed into a print with the selected finish. Controller 265 operates fixing station 60 after fixing member 62, 260, or 270 is received by receptacle 300.

In one example, controller 265 operates fixing station 60 with first rotatable fixing member 62 to produce prints with a G60 gloss of less than five. In another example, controller 265 operates fixing station 60 with second rotatable fixing member 260 to produce prints with a G60 gloss of between 10 and 35.

In various embodiments, printer 100 includes a third rotatable fixing member 270 with a sufficiently smooth fluoropolymer surface. Receptacle 300 receives third rotatable fixing member 270 and controller 265 operates fixing station 60 with third rotatable fixing member 270 to produce prints with a G60 gloss of greater than 30. Third rotatable fixing member 270 has a Rₐ, R_{z} and Rₘₐₓ less than that of second rotatable fixing member 260.

These embodiments advantageously provide three finish options, depending on which of the three fixing members is installed in the receptacle 300, and by using low viscosity toners.

In various embodiments, printer 100 can include a media database 267 operationally connected to controller 265. Controller 265 provides the selected finish to database 267 and receives operational settings 269 from database 267.

Printer 100 can further include a user interface 268 operatively connected to database 267. Database 267 is adapted to receive operational settings 269 for specified finishes and store operational settings 269 for the selected finishes in database 267.

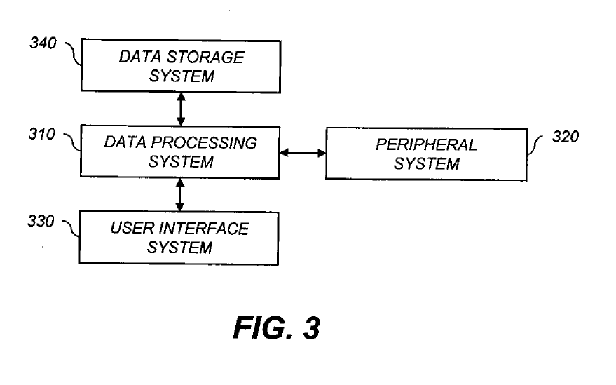

FIG. 3 is a high-level diagram showing the components of a processing system useful with various embodiments. The system includes a data processing system 310, a peripheral system 320, a user interface system 330, and a data storage system 340. Peripheral system 320, user interface system 330, and data storage system 340 are communicatively connected to data processing system 310.

Data processing system 310 includes one or more data processing devices that implement the processes of various embodiments, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

Data storage system 340 includes one or more processor-accessible memories configured to store information, including the information needed to execute the processes of the various embodiments, including the example processes described herein. Data storage system 340 can be a distributed processor-accessible memory system including multiple processor-accessible memories communicatively connected to data processing system 310 via a plurality of computers or devices. On the other hand, data storage system 340 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. The phrase “communicatively connected” is intended to include a connection between devices or programs within a single data processor, a connection between devices or programs located in different data processors, and a connection between devices not located in data processors at all. In this regard, although the data storage system 340 is shown separately from data processing system 310, one skilled in the art will appreciate that data storage system 340 can be stored completely or partially within data processing system 310. Further in this regard, although peripheral system 320 and user interface system 330 are shown separately from data processing system 310, one skilled in the art will appreciate that one or both of such systems can be stored completely or partially within data processing system 310.

Peripheral system 320 can include one or more devices configured to provide digital content records to data processing system 310. For example, peripheral system 320 can include digital still cameras, digital video cameras, cellular phones, or other data processors. Data processing system 310, upon receipt of digital content records from a device in peripheral system 320, can store such digital content records in data storage system 340. Peripheral system 320 can also include a printer interface for causing a printer to produce output corresponding to digital content records stored in data storage system 340 or produced by data processing system 310.

User interface system 330 can include a mouse, a keyboard, another computer, or any device or combination of devices from which data is input to data processing system 310. In this regard, although peripheral system 320 is shown separately from user interface system 330, peripheral system 320 can be included as part of user interface system 330.

User interface system 330 also can include a display device, a processor-accessible memory, or any device or combination of devices to which data is output by data processing system 310. In this regard, if user interface system 330 includes a processor-accessible memory, such memory can be part of data storage system 340 even though user interface system 330 and data storage system 340 are shown separately in FIG. 1.

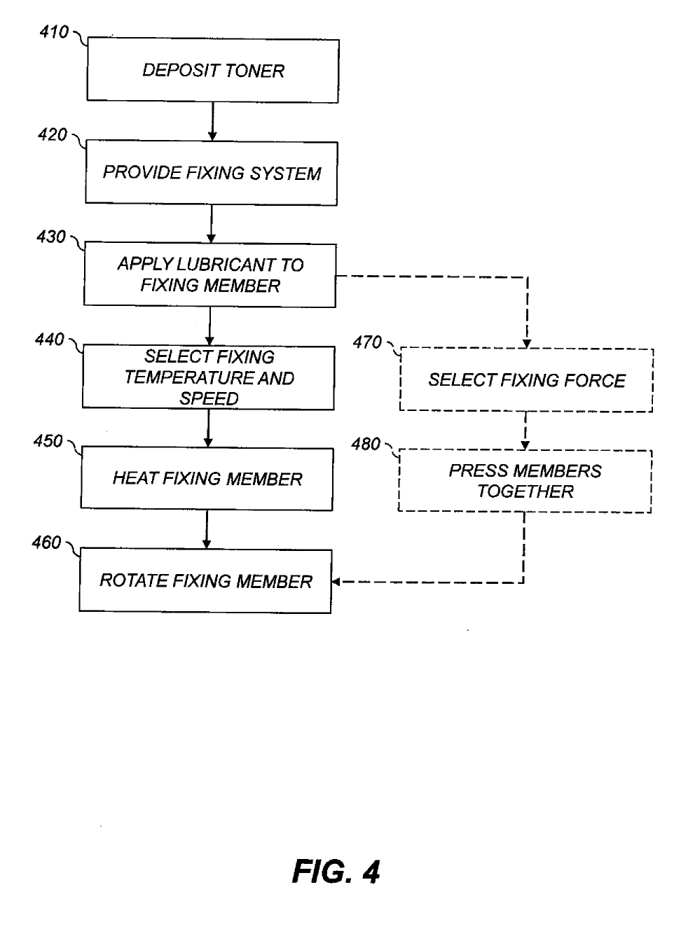

FIG. 4 is a flowchart of methods of producing a print having a matte finish on a receiver having a type. The type includes surface type and basis weight as discussed above. Processing begins with step 410.

In step 410, toner is deposited in a selected pattern on a receiver 42A e.g., by electrophotography, e.g., as discussed above with reference to FIG. 1. The toner can include particles. The toner has a viscosity at 120° C. of less than about 10 kpoise. Step 410 is followed by step 420.

In step 420, a fixing system is provided. The fixing system includes a rotatable fixing member 62, 260, or 270 and a rotatable pressure member 64 arranged to form a fixing nip 66 between them. An example of such a fixing system is shown in FIG. 2, as discussed above. A fixing surface of the fixing member includes silicone and has a selected non-smooth surface. A “non-smooth surface” is a surface with average roughness Rₐ>0.15 μm or greater than 1.25 μm. Step 420 is followed by step 430.

In step 430, a lubricant 263 is applied to fixing member 62, 260, or 270. Various structures can be used to apply lubricant 263. Examples include wicks, metal roller, silicone roller, rotating wicks, doctor blades or fluoropolymer donor roller oilers. In various embodiments, lubricant 263 is applied at normalized oiling rates between 0.5 mg/A4 to 7 mg/A4. For examples of donor rollers, see U.S. Pat. No. 4,254,732 and U.S. Pat. No. 6,721,529, the disclosures of which are incorporated herein by reference. For examples of wicks, see U.S. Pat. No. 5,732,317, the disclosure of which is incorporated herein by reference. In various embodiments, step 430 is followed by step 440.

In step 440, a fixing temperature and a fixing speed are selected based on the receiver type. In various embodiments, the fixing temperature is between 125° C. and 200° C., inclusive. In various embodiments, the selection is performed automatically using a controller 265 with a database 267 and inputs for receiver type. Controller 265 can be a general purpose processor or logic device, or a system such as that shown in FIG. 3, discussed above. Step 440 is followed by step 450.

In step 450, the fixing member 62, 260, or 270 is heated to have a surface temperature substantially equal to (within +/−5 degrees ° C. of) the selected fixing temperature. Step 450 is followed by step 460.

In step 460, the fixing member 62, 260, or 270 is rotated at the selected fixing speed, +/−10 mm/sec, and the pressure member 64 is simultaneously rotated to draw the receiver 42A through the fixing nip 66, so that the toner is heated and fixed to receiver 42A and the resulting print has a matte finish. In various embodiments, the fixing speed is between 170 min/sec and 640 mm/sec., inclusive.

In other embodiments, fixing force is controlled. In these embodiments, steps 410, 420, and 430 are as described above. Step 430 is followed by step 470.

In step 470, the fixing force is selected. The nip loading force is automatically controlled based on the receiver type using a controller 265 connected to database 267 and inputs for receiver type. In various embodiments, the fixing force is between 404 Newtons and 4546 Newtons, inclusive, with resulting nip pressure between 0.1 Mpa and 0.7 Mpa, inclusive. Step 470 is followed by step 480.

In step 480, fixing member 62, 260, or 270 and pressure member 64 press together with the fixing force +/−5% of the requested load, or +/−10% for springs. Springs can be used to press fixing member 62, 260, or 270 and pressure member 64 together. A multiple-step cam can be rotated to select from two or more loads. Step 480 is followed by step 460. Step 460 is as described above.

In various embodiments, the temperature and nip width or nip load can be varied based upon the paper that is being fused on a sheet-to-sheet basis. This can be read from the media database 267. All of the receivers run at the same nominal speed.

FIG. 5 is a diagram of the receptacle system adapted to receive and retain fixing members 62, 260, 270. For clarity, only fixing member 62 is shown.

Fixing member 62 or 260, or 270 is adapted to be retained by a receptacle 300. Received fixing member 62 has a bearing at both ends, connected to brackets and placed on a rotatable shaft, which permit the received fixing member 62, 260, or 270 to rotate when placed inside receptacle 300. Receptacle 300 includes two brackets that receive respective bearings on fixing member 62, 260, or 270. In an example, the brackets are C-shaped metal plates on each side of received fixing member 62, 260, or 270.

Receptacle 300 is movable between two different positions 510 or 520. In the first position 510, received fixing member 62, 260, or 270 is retained by receptacle 300 and is in contact with pressure member 64. This permits receiver 42A to follow transport path 281 (not shown) and enter fixing station 60. In fixing station 60, receiver 42A is drawn through fixing nip 66, so that the toner particles on receiver 42A can be fixed into a print with the selected finish. In the second position 520, received fixing member 62, 260, or 270 is separated from pressure member 64 so that received fixing member 62, 260, or 270 can be removed and replaced with a different fixing member 62, 260, or 270, as discussed above with respect to FIG. 2.

In various embodiments, printer 100 includes a mount 570 that is fixed with respect to pressure member 64. By “fixed”, it is meant that mount 570 has a mechanically static position with respect to pressure member 64. Normal variations due to thermal and mechanical stress are included in “fixed.” Low amplitude vibrations and other small scale motion is also included in “fixed.”Receptacle 300 is connected to mount 570 by a hinge 580 or any other connecting mechanism that permits the receptacle to rotate along an axis of rotation 590 different than the axis of rotation 591 of the received fixing member 62, 260, 270 in receptacle 300. This permits receptacle 300 to rotate between the first and second positions. This permits efficient loading and unloading of the desired fixing member 62, 260, or 270. As receptacle 300 rotates, the fixing member 62, 260, or 270 goes from being in contact with pressure member 64 in first position 510 to being separated from pressure member 64 in second position 520 because the axes of rotation of the receptacle 300 and of the fixing member 62, 260, or 270 are offset from each other.

In various embodiments, receptacle 300 rotates with respect to mount 570, from the first position 510, 0°, in which position fixing member 62, 260, or 270 is retained in contact with pressure member 64, to the second position 520 with respect to mount 570, 90°, in which position fixing member 62, 260, or 270 is separated from pressure member 64. When receptacle 300 is at 90°, receptacle 300 receives the fixing member 62, 260, or 270. If a fixing member 62, 260, or 270 is already present in receptacle 300, that fixing member 62, 260, or 270 can be removed so that receptacle 300 can receive another fixing member 62, 260, or 270. Angles measured with respect to mount 570 increase in the direction of rotation of receptacle 300 away from the first position 510.

In various embodiments, applicator 562 includes lubricant pan 565. Lubricant pan 565 is a vessel that holds a quantity of lubricant 263 and can be a pan or some other container. A first rotatable roller 563 is submerged in lubricant pan 565. First roller 563 carries liquid up to an intermediate rotatable second roller 564, which is parallel and in contact with first roller 563. Lubricant 263 transfers from first roller 563 to second roller 564, whence it transfers to received fixing member 62, 260, or 270. The resulting transaction lubricates the received fixing member 62, 260, or 270.

In various embodiments, first roller 563 has an aluminum or steel metal surface. In various embodiments, second roller 564 has a fluoropolymer surface.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

21 charger
21a voltage source
22 exposure subsystem
23 toning station
23a voltage source
25 photoreceptor
25a voltage source
31, 32, 33, 34, 35, 36 printing module
38 print image
39 fused image
40 supply unit
42, 42A, 42B receiver
50 transfer subsystem
60 fixing station
62 fixing member
64 pressure member
66 fixing nip
68 release fluid application substation
70 output tray
81 finisher
86 transport web
99 cleaning station
100 logic and control unit (LCU)
100 printer
260 second rotatable fixing member
262 applicator
263 lubricant
264 bearing
265 controller
266 operational settings
267 database
268 user interface
269 operational settings
270 third rotatable fixing member
274 bearing
281 transport path
284 bearing
300 receptacle
310 data processing system
320 peripheral system
330 user interface system
340 data storage system
410 deposit toner step
420 provide fixing system step
430 apply lubricant to fixing member step
440 select fixing temperature and speed step
450 heat fixing member step
460 rotate fixing member step
470 select fixing force step
480 press members together step
510 first position
520 second position
562 applicator
563,564 roller
565 lubricant pan
570 mount
580 hinge
590,591 axis of rotation

1. A method of producing a print having a matte finish on a receiver having a surface type and basis weight comprising:
a) depositing toner in a selected pattern on the receiver, wherein the toner has a viscosity of less than about 10 kpoise;
b) providing a fixing station including a rotatable fixing member and a pressure member arranged to form a fixing nip between them, wherein the fixing member has a selected non-smooth surface that includes silicone;
c) applying a release lubricant to the fixing member;
d) selecting a fixing temperature and a fixing speed based on the receiver surface type;
e) heating the fixing member to have a surface temperature substantially equal to the selected fixing temperature; and
f) rotating the fixing member at the selected fixing speed to draw the toned receiver through the fixing nip, so that the toner is heated and fixed to the receiver and the resulting print has a matte finish.

2. The method according to claim 1, wherein the release lubricant contains amines.

3. The method according to claim 1, wherein the selecting step includes selecting a media type and receiving, from a database, the fixing temperature or fixing speed corresponding to the media type.

4. The method according to claim 1, wherein the matte finish has a G60 gloss of less than 5.

5. The method according to claim 1, wherein the fixing member has a mechanically-ground surface.

6. The method according to claim 1, wherein the toner includes polyester resin.

7. A method of producing a print having a matte finish on a receiver having a type, comprising:
a) depositing toner in a selected pattern on the receiver, wherein the toner has a viscosity of less than about 10 kpoise;
b) providing a fixing station including a rotatable fixing member and a pressure member arranged to form a fixing nip between them, wherein a fixing surface of the fixing member includes silicone and has a selected non-smooth surface;
c) applying a release lubricant to the fixing member;
d) selecting a fixing force based on the receiver type;
e) pressing the fixing member and the pressure member together with the fixing force; and
f) rotating the fixing member to draw the toned receiver through the fixing nip, so that the toner is heated and fixed to the receiver and the resulting print has a matte finish.

8. The method according to claim 7, wherein the release lubricant contains amines.

9. The method according to claim 7, wherein the selecting step includes selecting a media type and receiving, from a database, the fixing force corresponding to the media type.

10. The method according to claim 7, wherein the matte finish has a G60 gloss of less than 5.

11. The method according to claim 7, wherein the fixing member has a mechanically-ground surface.

12. The method according to claim 7, wherein the toner includes polyester resin.
